(19) United States
(12) Patent Application Publication
(10) Pub. No.: US 2019/0373350 A1
(43) Pub. Date: Dec. 5, 2019

(54) EARPHONE FOR TRANSMITTING AND RECEIVING SIGNALS THROUGH METAL BRACKET AS ANTENNA

(71) Applicant: Innovation Sound Technology Co., Ltd., Shenzhen (CN)

(72) Inventors: Shun Ming Yuen, Shenzhen (CN); Wai Yin Mung, Shenzhen (CN); Ka Ming Wu, Shenzhen (CN)

(21) Appl. No.: 16/540,036

(22) Filed: Aug. 13, 2019

Related U.S. Application Data
(63) Continuation-in-part of application No. PCT/CN2018/101985, filed on Aug. 23, 2018.

(30) Foreign Application Priority Data
Feb. 12, 2018 (CN) 201820253472.1

(51) Int. Cl. H04R 1/10; H01Q 1/24; H01Q 1/44; H01Q 1/27

(52) U.S. Cl. CPC H04R 1/105; H01Q 1/24; H04R 2420/07; H01Q 1/273; H04R 1/1075; H01Q 1/44

(57) ABSTRACT

The present invention discloses an earphone for transmitting and receiving signals through a metal bracket as an antenna, comprising a bracket. Both ends of the bracket are respectively fixed to a fixing frame; the upper part of the fixing frame is used for installing a first antenna and a second antenna; the other end of the first antenna and the second antenna penetrates through a housing, extends into the housing, and is welded to a PCB inside the housing. A loudspeaker is arranged in the housing. The loudspeaker is connected with the PCB. The present invention uses a retractable metal bracket of a traditional earphone as an antenna, thereby removing a traditional wireless earphone antenna hidden into a shell, and designs an earphone bracket as an antenna to become a part of the appearance, so that the earphone product can better complete transmission and reception.

### CROSS REFERENCE TO RELATED APPLICATIONS

The present application is a Continuation-In-Part Application of PCT Application No. PCT/CN2018/101985 filed on Aug. 23, 2018, which claims the benefit of Chinese Patent Application No. 201820253472.1 filed on Feb. 12, 2018. All the above are hereby incorporated by reference.

### TECHNICAL FIELD

The present invention specifically relates to an earphone for transmitting and receiving signals through a metal bracket as an antenna, and belongs to the technical field of earphones.

### BACKGROUND

A wireless antenna of the traditional earphone is hidden in a shell. Therefore, the appearance is not artistic in use, and the reception of signals is also affected, so that it is inconvenient to use.

### SUMMARY

To solve the technical problems to overcome the existing defects, the present invention provides an earphone for transmitting and receiving signals through a metal bracket as an antenna, and uses a retractable metal bracket of the traditional earphone as an antenna, thereby removing a traditional wireless earphone antenna hidden into a shell, and designs an earphone bracket as an antenna to become a part of the appearance, so that the earphone product can better complete transmission and reception, thereby effectively solving the problems in the background.

To solve the above technical problems, the present invention provides the following technical solution:

The present invention provides an earphone for transmitting and receiving signals through a metal bracket as an antenna, comprising a bracket. Both ends of the bracket are respectively fixed to a fixing frame; the upper part of the fixing frame is used for installing a first antenna and a second antenna; the other end of the first antenna and the second antenna penetrates through a housing, extends into the housing, and is welded to a PCB inside the housing. A loudspeaker is arranged in the housing. The loudspeaker is connected with the PCB.

As a preferred technical solution of the present invention, the first antenna and the second antenna are two sets of antennas, and each set of antennas is respectively provided with two antennas.

As a preferred technical solution of the present invention, the earphone for transmitting and receiving signals through a metal bracket as an antenna further comprises plastic parts; and the plastic parts are installed on one end of each set of the first antenna and the second antenna, and fixed to each set of the first antenna and the second antenna.

As a preferred technical solution of the present invention, the earphone for transmitting and receiving signals through a metal bracket as an antenna further comprises a radio frequency transceiver, a radio frequency switch and a matching network; one end of the first antenna and the second antenna is connected with the matching network; and the matching network is connected with the radio frequency transceiver through the radio frequency switch.

As a preferred technical solution of the present invention, the first antenna and the second antenna are two sets of antennas, and each set of antennas can also be respectively set as one antenna.

As a preferred technical solution of the present invention, the first antenna and the second antenna are two sets of antennas.

The present invention achieves the beneficial effects: the earphone for transmitting and receiving signals through a metal bracket as an antenna uses a retractable metal bracket of the traditional earphone as an antenna, thereby removing a traditional wireless earphone antenna hidden into the shell, and designs an earphone bracket as an antenna to become a part of the appearance, so that the earphone product can better complete transmission and reception.

### DESCRIPTION OF DRAWINGS

The drawings are used to provide further understanding for the present invention and constitute part of the description. The drawings are used to explain the present invention together with the embodiments of the present invention, and do not constitute a limitation to the present invention.

In the figures:

FIG. 1 is a structural schematic diagram of an earphone.

FIG. 2 is an assembly stereogram of a fixing component and a bracket in an earphone.

FIG. 3 is a schematic diagram of an earphone.

Numerals in the figures: 1 bracket; 2 plastic part; 3 first antenna; 4 fixing frame; 5 housing; 6 loudspeaker; 7 second antenna; 8 PCB; 9 radio frequency transceiver; 10 radio frequency switch; and 11 matching network.

### DETAILED DESCRIPTION

The preferred embodiment of the present invention will be described below in combination with the drawings. It should be understood that the preferred embodiment described herein is only used for describing and explaining the present invention, but is not used for limiting the present invention.

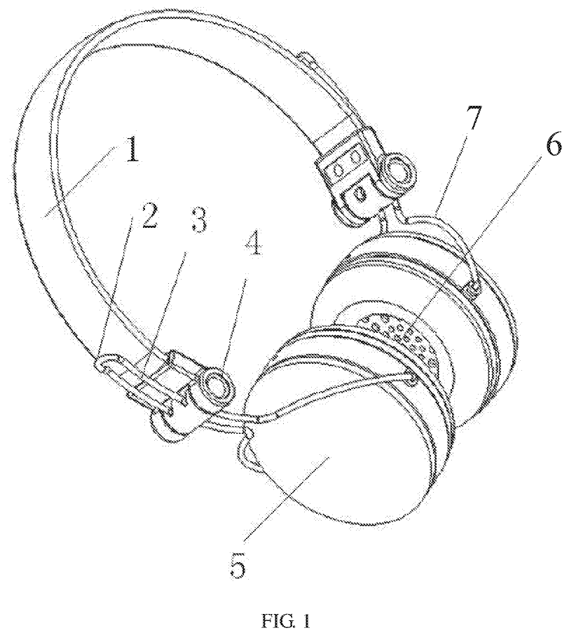

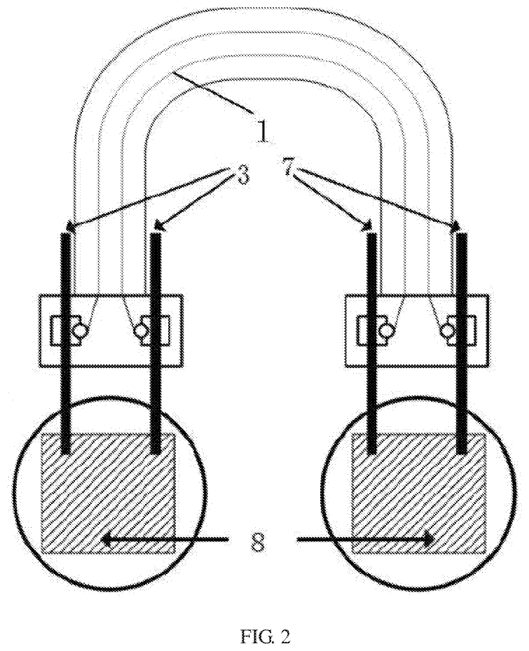

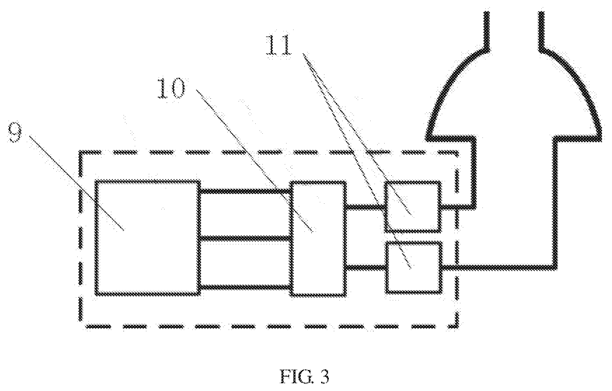

Embodiment: with reference to FIGS. 1-3, an earphone for transmitting and receiving signals through a metal bracket as an antenna in the utility model comprises a bracket 1; both ends of the bracket 1 are respectively fixed to a fixing frame 4; the upper part of the fixing frame 4 is used for installing a first antenna 3 and a second antenna 7; the other end of the first antenna 3 and the second antenna 7 penetrates through a housing 5, extends into the housing 5, and is welded to a PCB 8 inside the housing 5; a loudspeaker 6 is arranged in the housing 5; and the loudspeaker 6 is connected with the PCB 8. The first antenna 3 and the second antenna 7 are two sets of antennas, and each set of antennas is respectively provided with two antennas. The earphone further comprises plastic parts 2; and the plastic parts 2 are installed on one end of each set of the first antenna 3 and the second antenna 7, and fixed to each set of the first antenna 3 and the second antenna 7. The earphone further comprises a radio frequency transceiver 9, a radio frequency switch 10 and a matching network 11; one end of the first antenna 3 and the second antenna 7 is connected with the matching network 11; and the matching network 11 is connected with the radio frequency transceiver 9 through the radio frequency switch 10. The first antenna 3 and the second antenna 7 are two sets of antennas, and each set of antennas can also be respectively set as one antenna, which can be configured according to actual effects.

The first antenna 3 and the second antenna 7 are two sets of antennas, which can be configured by electroplating according to the appearance or using a rubber shell as protection or appearance.

It should be noted that the present invention is the earphone for transmitting and receiving signals through a metal bracket as an antenna, and uses a retractable metal bracket of the traditional earphone as an antenna during work, thereby removing a traditional wireless earphone antenna hidden into the shell, and designs an earphone bracket as an antenna to become a part of the appearance, so that the earphone product can better complete transmission and reception.

Finally, it should be noted that the above description is only a preferred embodiment of the present invention, and is not intended to limit the present invention. Although the present invention is described in detail with reference to the above embodiment, those skilled in the art may still modify the technical solution recorded in the above embodiment, or equivalently replace some of the technical features. Any modification, equivalent replacement, improvement, etc. made within the spirit and the principle of the present invention shall be included within the protection scope of the present invention.

What is claimed is:

1. An earphone for transmitting and receiving signals through a metal bracket as an antenna, comprising a bracket (1), characterized in that both ends of the bracket (1) are respectively fixed to a fixing frame (4); the upper part of the fixing frame (4) is used for installing a first antenna (3) and a second antenna (7); the other end of the first antenna (3) and the second antenna (7) penetrates through a housing (5), extends into the housing (5), and is welded to a PCB (8) inside the housing (5); a loudspeaker (6) is arranged in the housing (5); and the loudspeaker (6) is connected with the PCB (8).

2. The earphone for transmitting and receiving signals through a metal bracket as an antenna according to claim 1, characterized in that the first antenna (3) and the second antenna (7) are two sets of antennas, and each set of antennas is respectively provided with two antennas.

3. The earphone for transmitting and receiving signals through a metal bracket as an antenna according to claim 1, characterized by further comprising plastic parts (2); and the plastic parts (2) are installed on one end of each set of the first antenna (3) and the second antenna (7), and fixed to each set of the first antenna (3) and the second antenna (7).

4. The earphone for transmitting and receiving signals through a metal bracket as an antenna according to claim 2, characterized by further comprising plastic parts (2); and the plastic parts (2) are installed on one end of each set of the first antenna (3) and the second antenna (7), and fixed to each set of the first antenna (3) and the second antenna (7).

5. The earphone for transmitting and receiving signals through a metal bracket as an antenna according to claim 1, characterized by further comprising a radio frequency transceiver (9), a radio frequency switch (10) and a matching network (11); one end of the first antenna (3) and the second antenna (7) is connected with the matching network (11); and the matching network (11) is connected with the radio frequency transceiver (9) through the radio frequency switch (10).

6. The earphone for transmitting and receiving signals through a metal bracket as an antenna according to claim 2, characterized by further comprising a radio frequency transceiver (9), a radio frequency switch (10) and a matching network (11); one end of the first antenna (3) and the second antenna (7) is connected with the matching network (11); and the matching network (11) is connected with the radio frequency transceiver (9) through the radio frequency switch (10).

7. The earphone for transmitting and receiving signals through a metal bracket as an antenna according to claim 3, characterized by further comprising a radio frequency transceiver (9), a radio frequency switch (10) and a matching network (11); one end of the first antenna (3) and the second antenna (7) is connected with the matching network (11); and the matching network (11) is connected with the radio frequency transceiver (9) through the radio frequency switch (10).

8. The earphone for transmitting and receiving signals through a metal bracket as an antenna according to claim 4, characterized by further comprising a radio frequency transceiver (9), a radio frequency switch (10) and a matching network (11); one end of the first antenna (3) and the second antenna (7) is connected with the matching network (11); and the matching network (11) is connected with the radio frequency transceiver (9) through the radio frequency switch (10).

9. The earphone for transmitting and receiving signals through a metal bracket as an antenna according to claim 1, characterized in that the first antenna (3) and the second antenna (7) are two sets of antennas, and each set of antennas can also be respectively set as one antenna.

10. The earphone for transmitting and receiving signals through a metal bracket as an antenna according to claim 1, characterized in that the first antenna (3) and the second antenna (7) are two sets of antennas.
